(19) United States
(12) Patent Application Publication
(10) Pub. No.: US 2025/0008956 A1
(43) Pub. Date: Jan. 9, 2025

(54) COMPOSITIONS AND A METHOD OF IMPROVING PLANT HEALTH AND CONTROLLING INSECTS

(71) Applicant: UPL LIMITED, Mumbai (IN)

(72) Inventors: Prabhu ANNADURAI, Mumbai (IN); Parveen Singh CHAMBIAL, Mumbai (IN); Alejandro AREVALO, Cary, NC (US); Sean WHIPPLE, Concord TWP, OH (US)

(21) Appl. No.: 18/697,900

(22) PCT Filed: Oct. 4, 2022
(86) PCT No.: PCT/IN2022/050883

§ 371 Date: Apr. 2, 2024

(30) Foreign Application Priority Data
Oct. 5, 2021 (IN) 202121045249

(51) Int. Cl. A01N 43/40; A01N 25/04; A01N 25/12; A01P 7/04

(52) U.S. Cl. CPC A01N 43/40; A01N 25/04; A01N 25/12; A01P 7/04

(57) ABSTRACT

A method of improving plant health and controlling insect infestation in crops is disclosed. The invention also discloses a method of conferring and increasing phytotonic effect in cereal crops, oilseed crops and row crops 5 using the present method.

### FIELD OF INVENTION

The present invention relates to a method of improving plant health and controlling insect infestation in crops. More particularly, the present invention relates to compositions comprising a pyridylidene compound for conferring and increasing phytotonic effect in plants and effectively controlling insect infestation.

### BACKGROUND OF INVENTION

Rice is Asia's economically and culturally most important food crop. Rice cultivation is regarded as the single most important economic activity in Asia with more than 90% of rice, which is a common Asian staple food, being produced in Asia. In particular, rice production in three countries, China, India, and Indonesia accounts for 60% of the total global rice production.

However, rice cultivation in these areas is countered with a persistent problem of reduced grain yield due to excessive damage caused by Lepidoptera pests that feed on above-ground parts of rice plantations and Hemiptera pests that suck on foliage, especially Meichu, which is a Lepidopteran pest. Damage to rice crop caused by pests amounts to about 45%, therefore an effective control of these rice pests is essential for improving rice production. It is known that 2.7 billion of the global population is dependent on rice as its major source of food. By the year 2025, this number is likely to rise to 3.9 billion. This is perceived as a vital reason to improve the control of insect infestation in rice cultivations, to improve crop health and increase grain yield.

Although the average rice yield per area has increased tremendously in the last forty years, the yield gap between economically optimal and actual yields remains large in many farmer fields and in many countries. This yield difference may be caused by unfavourable environmental conditions and limited material inputs, but inefficient production technologies and lack of knowledge contribute greatly.

Currently, rice pest infestation occurs at different times and is controlled (systematic control) by using chemicals that are effective against each pest. Flupyrimin (FLP) [N-[(E)-1-(6-chloro-3-pyridinylmethyl) pyridin-2 (1H)-ylidene]-2,2,2-trifluoroacetamide], has unique biological properties, including outstanding potency to imidacloprid (IMI)-resistant rice pests together with superior safety toward pollinators.

As a pest control agent, flupyrimin has an insecticidal effect on planthoppers and butterfly pests such as planthoppers that occur in rice (paddy rice, etc.). It has been reported that its impact on environment is low, and that it can be mixed with other insecticides for the control of planthoppers, meichu, etc.

It has been observed by the present inventors that flupyrimin provides phytotonic effects on plants particularly in rice production, especially on the duration of pest control activity. Thus, the present invention relates to a method of increasing phytotonic effect in plants and at the same time effectively controls insect infestation in crops.

The present invention thus provides a commercially viable, safe and sustainable method to enhance plant growth and increase grain yield.

### SUMMARY OF INVENTION

In an aspect, the present invention provides an effective crop protection solution for a long period and promotes phytotonic effect in plants.

In another aspect, the present invention provides a method of conferring and increasing phytotonic effect in plants.

In another aspect, the present invention provides a method of conferring and increasing phytotonic effect in plants comprising applying flupyrimin to the locus of a plant, plant part, plant propagation material, or a growing plant.

In another aspect, the present invention provides a method of conferring and increasing phytotonic effect in cereal crops, row crops and oilseed crops comprising applying flupyrimin to the locus of a plant, plant part, plant propagation material, or any part thereof.

In another aspect, the present invention provides a composition comprising flupyrimin that when applied to the locus of a plant results in an increased yield of the crop and improved plant growth parameters.

In another aspect, the present invention provides compositions comprising flupyrimin or salts, N-oxide, solvate or polymorph or esters thereof, for conferring and increasing phytotonic effect in plants and controlling pests at the same time.

### DETAILED DESCRIPTION OF INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to. The term ‘plants’ refers to all physical parts of a plant, including seeds, seedlings, saplings, roots, tubers, stems, stalks, foliage and fruits.

The term “crop” refers to both, growing and harvested crops.

The term “locus” of a plant as used herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

The term ‘phytotonic effect’ as used herein refers to improved growth parameters of a plant crop including the following features with respect to root, shoot development and grain yield.

As used herein, phytotonic effect with respect to improved plant root parameters refers to inclusive growth of the fibrous root system, increased number of tertiary and white roots and increased root length.

As used herein, phytotonic effect with respect to improved plant shoot parameters refers to the inclusive growth of the stem, strong and sturdy tillers and broader leaves.

As used herein, phytotonic effect with respect to improved plant tiller parameters in rice cultivation refers to an increase in the number of tillers, an increase in the number of productive tillers and an increase in tiller strength and sturdiness.

It has surprisingly been found that a Pyridylidene compound as used in the present invention is effective in controlling insect infestation in standing crops, specifically rice and also promotes phytotonic effects in plants. Plant health was considerably improved by the present method with present composition comprising flupyrimin compared to untreated plants and conventionally used agrochemicals for insect control.

The present inventors have observed comprehensive improvement in the plant growth parameters with respect to root, shoot development and grain yield in crops, preferably row and cereal crops treated with flupyrimin by the method as disclosed in the present invention. The present inventors have surprisingly found significantly superior plant growth parameters in rice crops treated with flupyrimin, in terms of growth of the fibrous root system, increased number of tertiary and white roots, increased root length, increase in the number of tillers, an increase in the number of productive tillers and an increase in tiller strength and sturdiness of the tillers and other such productive growth parameters. It is vital to note here that conventionally used market standards have not produced such superior plant growth features thus resulting in poor yield and poor growth parameters.

The present invention thus provides a method for regulating or improving plant growth and health comprising applying a pyridylidene compound to a locus of a plant, plant part, plant propagation material, or growing plant.

In an embodiment, the pyridylidene compound that belongs to class 4 of IRAC, preferably the insecticide compound selected from, at least one nicotinic acetylcholine receptor (nAChR) competitive modulator, more preferably the insecticide compound is flupyrimin.

The present invention thus provides a method for regulating or improving plant growth and health comprising applying flupyrimin to a locus of a plant, plant part, plant propagation material, or growing plant according to the method of the present invention.

In an embodiment, flupyrimin is applied as a salt, N-oxide, solvate or polymorph or esters thereof, for conferring and increasing phytotonic effect in plants and controlling pests at the same time.

In an embodiment, the present invention provides a method for regulating and improving plant growth comprising applying flupyrimin to a locus of a plant, a plant part, a plant propagation material, or a part thereof.

The present invention thus provides a method for regulating or improving the growth of a plant, wherein the method comprises applying flupyrimin to a locus of a plant, plant part, plant propagation material, or a growing plant a composition according to the present invention.

The present invention also provides a method for enhancing the yield of a plant, wherein the method comprises applying to the plant, or plant growing locus a composition according to the present invention.

The present invention also provides a method for safening a plant against phytotoxic effects of chemicals, comprising applying to a locus of a plant, plant part, plant propagation material, or a locus of a plant a composition comprising flupyrimin according to the present invention.

The present invention also provides a method of improving the tolerance of a plant to abiotic stress, wherein the method comprises applying to a locus of a plant, plant part, plant propagation material, or a locus of a plant growing a composition comprising flupyrimin according to the present invention.

In an embodiment a method for increasing yield in a plant is also provided and comprises applying to a locus of a crop, a plant, or an area of cultivation an effective amount of formulation comprising flupyrimin or salts thereof.

The composition is applied in an amount sufficient to produce the desired response, i.e. regulating and improving the growth of a crop, improving plant vigour, improving plant quality, improving tolerance to stress factors, an improved input use efficiency and such other features that enhance the activity of the crop.

The term “regulating or improving the growth of a crop” as used herein means an improvement in plant vigour/yield, an improvement in plant greenery and quality of the plant.

The term “improvement in plant vigour” means that certain effects/traits of plants are improved qualitatively or quantitatively when compared with the same trait in a control plant which has been grown under the same conditions in the absence of the method of the invention. Such effects include, but are not limited to, an increased root growth, a more developed root system, increased root nodulation, increased shoot growth, increased number of tillering, stronger tillers, more productive tillers, increased or improved plant stand, an increase and/or improvement in plant height, greener leaf colour, increased pigment content, increased photosynthetic activity and the like.

Accordingly, a plant with improved vigour may have an increase in any of the effects/traits or any combination or two or more of the traits.

The term ‘improvement in plant quality’ as used herein means that certain effects are improved qualitatively or quantitatively when compared with the same effect in a control plant which has been grown under the same conditions in the absence of the method of the invention. Such effects include, but are not limited to, improved visual appearance of the plant, improved quality of harvested material, improved protein content, improved oil content and composition, improved nutritional value, reduction in anti-nutritional compounds, improved organoleptic properties (e.g. improved taste) and/or improved consumer health benefits (e.g. increased levels of vitamins and anti-oxidants)), improved post-harvest characteristics (e.g. enhanced shelf-life and/or storage stability. A plant with improved quality may have an increase in any of the effects or any combination or two or more of the aforementioned effects.

In an embodiment, there may be an improved tolerance to stress factors' means that certain traits are improved qualitatively or quantitatively when compared with the same trait in a control plant which has been grown under the same conditions in the absence of the method of the invention. Such traits include, but are not limited to, an increased tolerance and/or resistance to biotic and/or abiotic stress factors.

The term “an improved input use” efficiency as used herein means that the plants are able to grow more effectively using given levels of inputs compared to the grown of control plants which are grown under the same conditions in the absence of the method of the invention. Typically, the inputs include, but are not limited to fertiliser (such as nitrogen, phosphorous, potassium, micronutrients), light and water. A plant with improved input use efficiency may have an improved use of any of the aforementioned inputs or any combination of two or more of the aforementioned inputs.

Any or all of the above crop enhancements may lead to an improved yield by improving e.g. plant physiology, plant growth and development and/or plant architecture.

According to the present invention, the term yield includes, but is not limited to, (i) an increase in biomass production, grain yield, starch content, oil content and/or protein content, which may result from (a) an increase in the amount produced by the plant per se or (b) an improved ability to harvest plant matter, (ii) an improvement in the composition of the harvested material (e.g. improved sugar acid ratios, improved oil composition, increased nutritional value, reduction of anti-nutritional compounds, increased consumer health benefits) and/or (iii) an increased/facilitated ability to harvest the crop, improved processability of the crop and/or better storage stability/shelf life. Typically, increased yield of an agricultural plant means that, where it is possible to take a quantitative measurement, the yield of a product of the respective plant is increased by a measurable amount over the yield of the same product of the plant produced under the same conditions, but without application of the present invention.

According to the present invention, it is preferred that the yield be increased by at least 0.5%, more preferred at least 1%, even more preferred at least 2%, still more preferred at least 5% or even more and so on.

The compositions of the present invention generally include agrochemical formulation adjuvants/carriers or agrochemically acceptable excipients.

The composition can be in the form of solid or liquid form. Preferably the liquid formulations for example are suspension concentrate formulation, an emulsifiable concentrate formulation and flowable concentrates are used in the present method.

Preferably the solid formulations for example granular formulation are used in the present method. The formulation can be ready-to-use compositions.

In an embodiment, the formulation is a flowable concentrate formulation for seed treatment.

In an embodiment, the composition is a suspension concentrate formulation.

In an embodiment, the composition is a granular formulation.

In an embodiment, the composition is a flowable concentrate formulation for seed treatment.

The compositions used in the present method comprise from about 0.1 to 99% by weight, especially from 0.1 to 95% by weight of the active ingredients and from 1 to 99.9% by weight of the adjuvant/carrier in a formulation.

The composition of the present invention may be applied to a plant, part of the plant, plant organ, plant propagation material or a plant growing locus.

In an embodiment, the total amount of insecticidal compound in the composition may typically be in the range of 0.1 to 99% by weight, preferably 0.2 to 90% by weight.

According to an embodiment, an optional active may be admixed with an adjuvant or a bio-stimulant or another agrochemical or a fertilizer compound such that the two components may be tank mixed with flupyrimin before spraying or using seed treatment.

In an embodiment, the constituents of the composition of the present invention may be tank mixed and sprayed at the locus or may alternatively be mixed with surfactants and then sprayed.

In an embodiment, the constituents of the composition of the present invention may be used for foliar application, ground or applications to plant propagation materials.

The composition may be applied pre-emergence or post-emergence. When the composition is used to regulate the growth of crop plants or enhance the tolerance to abiotic stress, it may be applied post-emergence of the crop.

The rates of application of compositions may vary within wide limits and depend on the nature of the soil, the method of application (pre- or post-emergence; seed dressing; application to the seed furrow; no tillage application etc.), the crop plant, the prevailing climatic conditions, and other factors governed by the method of application, the time of application and the target crop. For foliar or drench application, the compositions are generally applied at a rate of from 1 to 2000 g/ha, especially from 5 to 1000 g/ha. For seed treatment the rate of application is generally between 0.0005 and 150 g per 100 kg of seed.

In an embodiment, the present invention provides a granular formulation comprising flupyrimin or its salts ranging from 1% to 20% w/w of the composition.

In an embodiment, the present invention provides a granular formulation comprising flupyrimin or its salts ranging from 1% to 10% w/w of the composition.

In an embodiment, the present invention provides a flow concentrate formulation comprising flupyrimin in a concentration ranging from 10% to 60% w/w of formulation.

In an embodiment, the present invention provides a flow concentrate formulation comprising flupyrimin in a concentration ranging from 20% to 50% w/w of formulation.

In an embodiment, the present invention provides a flow concentrate formulation comprising flupyrimin in a concentration ranging from 20% to 30% w/w of formulation.

In an embodiment, the present invention provides a granular formulation comprising flupyrimin or its salts thereof as plant health promoters that causes an enhanced greening of the crops to which it is administered.

In an embodiment the present invention provides the granular formulation comprising flupyrimin or its salts thereof which enhances the protection of plants from attack or infestation by insects, acarids or nematodes.

In an embodiment the present invention provides the granular formulation comprising flupyrimin or its salts thereof that provides a greater number of tillers in flupyrimin treated rice crop against the market standards by an average of 2-3.

In an embodiment the root growth and tertiary root development with the granular formulation comprising flupyrimin or salts thereof is better than the market standards.

It is found that the composition comprising flupyrimin provides very good greening effect. Further, crop growth is consistently observed in all the demonstrations with flupyrimin formulations.

Typically, the advantages of the present invention comprise good root development and increase in number of tillers thereby making the crop more strong and more green plants as well as excellent control on yellow stem borer (YSB)—Scirpophaga incertulas.

In addition, no Nilaparvata lugens BPH (Brown plant hopper) infestation is found up-to 45 Days After application of composition comprising flupyrimin and/or a salt thereof.

Therefore, the present invention provides excellent results both in terms of insect management and overall crop vigour.

In an embodiment, the present method is used to improve plant vigor when flupyrimin and one or more safeners is applied to either the plant, or to its locus or to a plant propagation material.

In an embodiment, the present method is used to improve plant vigor when flupyrimin and one or more pesticides comprising fungicides, insecticides, herbicides or acaricides is applied to either the plant, or to its locus or to a plant propagation material.

In an embodiment the present invention provides a method of improving seed germination by applying flupyrimin and one or more pesticides comprising fungicides, insecticides, herbicides or acaricides to said plant or to its locus or to a plant propagation material.

In an embodiment, the method of the present invention improves the growth rate of a plant when flupyrimin and one or more pesticides comprising fungicides, insecticides, herbicides or acaricides is applied to either said plant or to its locus or to a plant propagation material.

In an embodiment, the method of the present invention provides an enhanced greening to the plant or its locus or a plant propagation material contacted with flupyrimin and one or more pesticides comprising fungicides, insecticides, herbicides or acaricides.

In a preferred embodiment, the present invention provides a method comprising applying flupyrimin and one or more insecticides to a locus of a plant to improve plant growth.

In a preferred embodiment, the present invention provides a method comprising applying flupyrimin and one or more insecticides to the surface of plant propagation material to improve plant growth.

In a preferred embodiment, the present invention provides a method comprising applying flupyrimin and one or more insecticides to seeds of a crop to improve seed vigour.

In an embodiment, the insecticide is from one or more of Acetylcholinesterase (AChE) inhibitors, Ryanodine receptor modulators, GABA-gated chloride channel blockers, Sodium channel modulators, Nicotinic acetylcholine receptor (nAChR) competitive modulators, Glutamate-gated chloride channel (GluCl) allosteric modulators, Chordotonal organ TRPV channel modulators, Inhibitors of mitochondrial ATP synthase, Mite growth inhibitors affecting CHS1, moulting disruptors, Microbial disruptors of insect midgut membranes, Inhibitors of acetyl CoA carboxylase, Mitochondrial complex electron transport inhibitors, Ecdysone receptor agonists, Inhibitors of chitin biosynthesis.

In an embodiment, the insecticide is from one or more of Ryanodine receptor modulator comprising Chlorantraniliprole, Cyantraniliprole, Cyclaniliprole Flubendiamide, Tetraniliprole.

In an embodiment, the insecticide is from one or more of Acetylcholinesterase (AChE) inhibitors comprising carbamates and organophosphates.

In an embodiment, the insecticide is from one or more of Nicotinic acetylcholine receptor (nAChR) competitive modulators, comprising Neonicotinoids comprising Acetamiprid, Clothianidin, Dinotefuran, Imidacloprid, Nitenpyram, Thiacloprid, and Thiamethoxam.

In an embodiment, the insecticide is from one or more of Sodium channel modulators comprising pyrethroids and pyrethrins comprising Acrinathrin, Allethrin, d-cis-trans Allethrin, dtrans Allethrin, Bifenthrin, Bioallethrin, Bioallethrin S-cyclopentenyl isomer, Bioresmethrin, Cycloprothrin, Cyfluthrin, betaCyfluthrin, Cyhalothrin, lambda-Cyhalothrin, gamma-Cyhalothrin, Cypermethrin, alphaCypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, Transfluthrin.

Moreover, flupyrimin or salts thereof does not show cross-resistance with other agrochemicals, is highly safe for non-target organisms, and has sufficiently excellent control activity at a low concentration. However, according to the present invention, any of these can be sustained for a particularly long period of time. For example, it contains and inhibits the proliferation and infestation by Meichu and planthoppers that occur at different times and cause great damage to rice by subjecting the locus to treatment with a solid preparation of the present invention containing the active ingredient flupyrimin and/or an acid addition salt thereof once. Two or more types of rice pests can also be suppressed to a low density for a long period of time. Therefore, according to the present invention, the yield of rice is expected to be improved, and simultaneous effect of reduction of drug sensitivity, environmental impact, sustainability of effect, impact on non-target organisms, and reduction of labor of agricultural workers are expected.

The rice pests on which the solid preparation of the present invention exhibits control activity are pests that can feed on rice leaves, stems, roots and ears; and pests that can be sucked from rice leaves, stems and ears. Such rice pests are not particularly limited, but for example, as agricultural and horticultural pests, Humiptera (Hemiptera) pests (Awayoto (Mythimna separata), Kobunomeiga, Cnaphalocosis patnalis (Marasmia patna) Futaobikoyaga (Naranga aenescens), Inetsutomushi (Parnara guttata), Inekin'uwaba (Plusia festucae), Kusashirokiyotou (Mythimna loreyi), Shiromadarakoyaga (Protodeltote distinguenda), Sugikiriyotou (Spodoptera depravata), Pelopidas mathias (Pelopidas mathias) and the like; Chilo suppressalis (rice stem borer, Chilo suppressalis), Sankameiga (San Kamei Chu, Scirpophaga incertulas), Ineyotou (Sesamia inferens), Scirphophaga innotata, Chilo polychrysus, hit such as Chilo auricilius), Hemiptera (Hemiptera) pest (wheat constricted aphid, wheat aphid, Scirpophaga indica, Dickladispa armi, Hemiptera (Rice, Hemiptera, Orseolia oryzae, etc.), Pseudomonas aeruginosa (Rice, Pseudomonas, etc.), Plants Rice singer nematode, Meloidogynae gramicola, etc.), etc., and one of these may be used alone or in combination of two or more. Among them, preferred are Hemiptera pests, Hemiptera pests, Zamiuma pests, Diptera pests, and Sheepidae pests, and more preferably planthoppers, leafhoppers, and leafhoppers. Examples include Nikameiga, Sankameiga, Himetobiunka, Tobiirounka, Sejirounka, Tsumaguro-yokobai, and Inazuma-yokobai, and more preferably, pests and pests among these.

The rice pest control method according to the present invention wherein the rice pest is at least one selected from the group consisting of planthoppers and meichu.

The preferred plants or its locus or the plant propagation material which may be treated using the method of the present invention include brassicas, such as broccoli, Chinese broccoli, Brussels sprouts, cauliflower, Cavalo broccoli, kohlrabi, cabbage, Chinese cabbage and Chinese mustard cabbage; cilantro; coriander; corn, cucurbits, such as chayote, Chinese waxgourd, citron melon, cucumber, gherkin, gourd, muskmelons (including cantalope, casaba, crenshaw melon, golden pershaw melon, honeydew melon, honey balls, mango melon, Persian melon, pineapple melon, Santa Claus melon and snake melon), pumpkins, summer squash, winter squash and watermelon; dried beans and peas, including bean, field bean, kidney bean, lima bean, pinto bean, navy bean, tepary bean, adzuki bean, blackeyed pea, catjang, cowpea, crowder pea, moth bean, mung bean, rice bean, southern pea, urd bean, broad bean, chickpea, guar, lablab bean, lentil, pea, field pea and pigeon pea; eggplant; lettuce; leafy brassicas/turnip greens including broccoli raab, bok choy, collards, kale, mizuna, mustard spinach, rape greens and turnip greens; okra; peppers; sod; soybeans; spinach; succulent peas and beans including pea, dwarf pea, edible-pod pea, English pea, garden pea, green pea, snow pea, sugar snap pea, pigeon pea, bean, broad bean, lima bean, runner bean, snap bean, wax bean, asparagus bean, yardlong bean, jackbean and sword bean; tobacco; tomatoes; and tuberous and corm vegetables including potato, sweet potato, arracacha, arrowroot, Chinese artichoke, Jerusalem artichoke, edible canna, cassava, chayote, chufa, dasheen, ginger, leren, tanier, turmer, yam bean and true yam.

In an embodiment, the preferred plants or its locus or the plant propagation material which may be treated using the method of the present invention is selected from cereal crops, oil seed crops and row crops.

In an embodiment, the cereal crops are wheat, rice, corn, rye, oats, barley, sorghum, and millets.

In an embodiment, the row crops are sunflower, potato, canola, dry bean, field pea, flax, safflower, buckwheat, cotton, maize, soybeans, and sugar beets.

In an embodiment, the oilseed crops are groundnut, rapeseed, mustard, soybean, sunflower, sesame, safflower and niger.

In an embodiment, the plant propagation material is a seed.

In an embodiment, the plant part is a tuber.

In an embodiment, the plant propagation material is selected from seeds of wheat, rice, corn, rye, oats, barley, sorghum, millets, sunflower, canola, dry bean, field pea, flax, safflower, buckwheat, cotton, maize, soybeans.

In an embodiment, the plant propagation material is a tuber selected from potato, sweet potato and sugar beets.

In an embodiment, flupyrimin is applied in an amount ranging from 10 g ai/ha to 1000 g ai/ha to the locus of a plant, plant part, or a growing plant.

In an embodiment, flupyrimin is applied in an amount ranging from 50 g ai/ha to 500 g ai/ha to the locus of a plant, plant part, or a growing plant.

In an embodiment, flupyrimin is applied in an amount ranging from 50 g ai/ha to 200 g ai/ha to the locus of a plant, plant part, or a growing plant.

In an embodiment, flupyrimin is applied in an amount ranging from 50 g ai/ha to 150 g ai/ha to the locus of a plant, plant part, or a growing plant.

In an embodiment, flupyrimin is applied at a rate ranging from 0.5 g ai/kg to 20 g ai/kg of seed to the locus of a plant propagation material.

In an embodiment, flupyrimin is applied at a rate ranging from 0.5 g ai/kg to 10 g ai/kg of seed to the locus of a plant propagation material.

In an embodiment, flupyrimin is applied at a rate ranging from 0.5 g ai/kg to 5 g ai/kg of seed to the locus of a plant propagation material.

In a preferred embodiment, the present invention provides a method of improving plant growth comprising applying flupyrimin to a locus of a plant, a plant part, a plant propagation material, or a part thereof;
wherein flupyrimin is applied in an amount ranging from 50 g ai/ha to 500 g ai/ha to the locus of a plant, plant part, or a growing plant; and
wherein flupyrimin is applied in an amount ranging from 0.5 g ai/kg to 10 g ai/kg of seed to the locus of a plant propagation material.

In a preferred embodiment, the present invention provides a method of improving plant growth comprising applying flupyrimin or its salts, N-oxide, solvate or polymorph or esters to a locus of a plant, a plant part, a plant propagation material, or a part thereof;
wherein flupyrimin is applied in an amount ranging from 50 g ai/ha to 500 g ai/ha to the locus of a plant, plant part, or a growing plant; and
wherein flupyrimin is applied in an amount ranging from 0.5 g ai/kg to 10 g ai/kg of seed to the locus of a plant propagation material.

In a preferred embodiment, the present invention provides a method of improving plant growth comprising applying flupyrimin to a locus of a plant, a plant part, a plant propagation material, or a part thereof;
wherein flupyrimin is applied in an amount ranging from 50 g ai/ha to 200 g ai/ha to the locus of a plant, plant part, or a growing plant.

In an embodiment, the present invention provides a method of improving plant growth comprising applying flupyrimin to a locus of a rice crop, or its part; wherein flupyrimin is applied in an amount ranging from 50 g ai/ha to 250 g ai/ha to the locus of the said crop.

In an embodiment, the present invention provides a method of improving plant growth comprising applying flupyrimin to a locus of a rice crop, or its part; wherein flupyrimin is applied in an amount ranging from 50 g ai/ha to 200 g ai/ha to the locus of the said crop.

In a preferred embodiment, the present invention provides a method of improving plant growth comprising applying flupyrimin to a locus of a rice crop, or its part; wherein flupyrimin is applied in an amount ranging from 50 g ai/ha to 150 g ai/ha to the locus of the said crop.

Injury in plants is often first noticed when the youngest partially unfurled leaf of the plant begins to whiter and die, resulting in a condition called dead heart. Dead hearts can be caused by any stem borer. Typical bore holes will be seen on the stem. Usually, a single larva is seen inside the stem. It remains inside the stem and feeds on the internal contents. The shoot of the affected plant can be pulled off easily, a symptom known as dead heart. At maturity, the grains become chaffy, which is known as white ear and eventually the whole plant finally dies.

The present inventors have observed that application of flupyrimin in rice has considerably reduced the count of dead hearts in rice crop to a negligible amount. Further, the present inventors have observed a considerable reduction in the number of white ears in rice plantations when treated with the present flupyrimin granular composition. The tiller strength and sturdiness have also proved to be significantly enhanced by applying the present method. The results have been addressed in tables 1 (a) to 1 (f) of the Examples.

In an embodiment, the present invention provides a method of improving plant growth comprising applying flupyrimin to a locus of a wheat crop, or a part thereof or its seed; wherein flupyrimin is applied in an amount ranging from 50 g ai/ha to 250 g ai/ha to the locus of the said crop.

In an embodiment, the present invention provides a method of improving plant growth comprising applying flupyrimin to a locus of a wheat crop, or a part thereof or its seed; wherein flupyrimin is applied in an amount ranging from 50 g ai/ha to 200 g ai/ha to the locus of the said crop.

In an embodiment, the present invention provides a method of improving plant growth comprising applying flupyrimin to a locus of a wheat crop, or a part thereof or its seed; wherein flupyrimin is applied in an amount ranging from 50 g ai/ha to 150 g ai/ha to the locus of the said crop.

In an embodiment, the present invention provides a method of improving plant growth comprising applying flupyrimin to seeds of wheat; wherein flupyrimin is applied in an amount ranging from 0.5 g ai/kg to 20 g ai/kg of seed.

In an embodiment, the present invention provides a method of improving plant growth comprising applying flupyrimin to seeds of wheat; wherein flupyrimin is applied in an amount ranging from 0.5 g ai/kg to 10 g ai/kg of seed.

The % germination, seed yield, weight, plant height, root length, plant vigor when wheat seeds were treated with flupyrimin was evaluated to be exemplary.

In an embodiment, the present invention provides a method of improving plant growth comprising applying flupyrimin to a locus of a mustard crop, or a part thereof or its seed; wherein flupyrimin is applied in an amount ranging from 50 g ai/ha to 250 g ai/ha to the locus of the said crop.

In an embodiment, the present invention provides a method of improving plant growth comprising applying flupyrimin to a locus of a mustard crop, or a part thereof or its seed; wherein flupyrimin is applied in an amount ranging from 50 g ai/ha to 200 g ai/ha to the locus of the said crop.

In an embodiment, the present invention provides a method of improving plant growth comprising applying flupyrimin to a locus of a mustard crop, or a part thereof or its seed; wherein flupyrimin is applied in an amount ranging from 50 g ai/ha to 150 g ai/ha to the locus of the said crop.

In an embodiment, the present invention provides a method of improving plant growth comprising applying flupyrimin to seeds of the mustard crop; wherein flupyrimin is applied in an amount ranging from 0.5 g ai/kg to 20 g ai/kg of seed.

In an embodiment, the present invention provides a method of improving plant growth comprising applying flupyrimin to seeds of the mustard crop; wherein flupyrimin is applied in an amount ranging from 0.5 g ai/kg to 10 g ai/kg of seed.

The plant height, root length, plant vigor when mustard seeds were treated with flupyrimin was evaluated to be exemplary.

In an embodiment, the present invention provides the use of the present method to enhance greening of the crops to which it is administered.

In an embodiment the present invention provides the use of the present method to enhance the protection of plants from attack or infestation by insects, acarids or nematodes.

### EXAMPLES

### Example 1: Efficacy of Flupyrimin on Growth Parameters in Rice Plants

The efficacy of flupyrimin in rice cultivation was observed in the present invention. The treatment conditions and the corresponding observations have been provided in tables 1 (a) to (f) below. The phytotonic effect of flupyrimin in rice crop in terms of the dead heart count, number of ears, productive tillers/hill and the hill stability were determined.

TABLE 1(a)

| | | Conc./Formulation | Dose (g |
|---|---|---|---|
| No. | Treatment | type | a.i./ha) |
| 1. | Untreated control | — | — |
| 2. | Flupyrimin | 2% GR | 150 |
| 3. | Cartap | 4% GR | 1000 |
| 4. | Cartap + | 7.75% GR | 581 |
| | EMA | | |
| | (Emamectin) | | |
| 5. | Fipronil | 0.6% GR | 60 |

GR: Granule formulation

TABLE 1 (b)
Dead heart count in rice crop

| | | | Dead hearts (count) | | | | |
|---|---|---|---|---|---|---|---|
| | | Dose | Pre- | 7 | 14 | 21 | 28 |
| No. | Treatment | (g a.i./ha) | count | DAA | DAA | DAA | DAA |
| 1. | Untreated | — | 0.00 | 2.36 | 3.39 | 3.60 | 2.80 |
| | control | | | | | | |
| 2. | Flupyrimin | 150 | 0.00 | 0.00 | 0.00 | 0.04 | 0.01 |
| 3. | Cartap | 1000 | 0.00 | 0.21 | 1.54 | 3.08 | 2.17 |
| 4. | Cartap + EMA | 581 | 0.00 | 0.00 | 0.46 | 1.60 | 1.17 |
| | (Emamectin) | | | | | | |
| 5. | Fipronil | 60 | 0.00 | 0.00 | 0.40 | 2.19 | 1.24 |

The observations were made at 7DAA, 14 DAA, 21 DAA and 28 DAA (days after application).

TABLE 1 (c)
White ear count in rice crop

| | | Dose | White |
|---|---|---|---|
| | | (g | ear/hill at |
| No. | Treatment | a.i./ha) | heading |
| 1. | Untreated control | — | 5.57 |
| 2. | Flupyrimin | 150 | 0.17 |
| 3. | Cartap | 1000 | 2.33 |
| 4. | Cartap + EMA | 581 | 1.37 |
| | (Emamectin) | | |
| 5. | Fipronil | 60 | 1.27 |

TABLE 1 (d)
Number of productive tillers per hill in rice crop

| | | Dose | No. of productive |
|---|---|---|---|
| | | (g | tillers/hill at |
| No. | Treatment | a.i./ha) | heading |
| 1. | Untreated control | — | 11.7 |
| 2. | Flupyrimin | 150 | 19.63 |
| 3. | Cartap | 1000 | 13.77 |
| 4. | Cartap + EMA | 581 | 16.8 |
| | (Emamectin) | | |
| 5. | Fipronil | 60 | 15.63 |

TABLE 1 (e)
Number of tillers per hill in rice crop

| | | Dose | No. of |
|---|---|---|---|
| | | (g | tillers/hill at |
| No. | Treatment | a.i./ha) | 45 DAA |
| 1. | Untreated control | — | 20.17 |
| 2. | Flupyrimin | 150 | 22.47 |
| 3. | Cartap | 1000 | 18.07 |
| 4. | Cartap + EMA | 581 | 20.6 |
| | (Emamectin) | | |
| 5. | Fipronil | 60 | 19 |

It was observed that the dead heart count and number of ears in rice was considerably negligible in crop treated with flupyrimin compared to conventionally used market standards and the untreated control. Further, the count of the productive tillers was also observed to be comparatively higher for crop treated with flupyrimin.

### Example 2: Evaluation of Tiller Sturdiness

The hill stability test was performed to determine the tiller strength of the hill. Accordingly, rice was subjected to flupyrimin treatment at 23 days after transplanting (DAT) and observations were taken at 20 DAA (days after application).

TABLE 1 (f)

| | Untreated control | Flupyrimin treated |
|---|---|---|
| Girth (mm) | 2842 | 4434 |

Hill stability is an important plant growth feature, as it protects the crop from lodging. It becomes especially important in tall varieties and in areas prone to high winds, cyclones, heavy rains etc. Due to hill stability, the plant is able to sustain the natural forces. Hill stability is also important in case of high pest and disease pressure, which makes the plant weak and loses the tiller strength. The girth of tillers treated with the flupyrimin composition (2% GR) had almost twice the girth compared to untreated rice.

### Example 3: Phytotonic Effect of Flupyrimin on Wheat

The present inventors have observed the phytotonic effect of flupyrimin in wheat by determining the % germination, plant height, root length (cm) and plant vigor The seeds were treated with 500 g/L flupyrimin flowable concentrate (FS) formulation. The observations were made at 30 DAS and 45 DAS (days after seeding).

TABLE 2
Efficacy of flupyrimin on % germination in wheat

| | Dose rates | | | | |
|---|---|---|---|---|---|
| | Active rate | Formulation | % Germination | | |
| | (g Al/kg of | rate (ml/kg | of Wheat Seed | | |
| Treatments | seed) | of seed) | 6 DAS | 9 DAS | 12 DAS |
| Untreated | — | — | 84.8 | 88.0 | 88.8 |
| check | | | | | |
| Flupyrimin | 1.2 | 2.4 | 92.0 | 93.0 | 95.5 |
| Flupyrimin | 2.0 | 4.0 | 92.0 | 93.8 | 96.0 |

TABLE 3
Efficacy of flupyrimin on plant height root Length
(cm) and plant vigor at 30 & 45 DAS in wheat

| | Dose rates | | | | | | | | Plant Vigor | |
|---|---|---|---|---|---|---|---|---|---|---|
| | Active | | Plant | | Root | | No. of | | (0-5 Index | |
| | rate | Form. rate | Height (cm) | | length (cm) | | tillers/plant | | scale) | |
| | (g Al/kg | (ml/kg of | 30 | 45 | 30 | 45 | 30 | 45 | 30 | 45 |
| Treatments | of seed) | seed) | DAS | DAS | DAS | DAS | DAS | DAS | DAS | DAS |
| Untreated | — | — | 38.7 | 52.1 | 8.10 | 9.20 | 4.3 | 4.7 | 3.0 | 3.3 |
| Flupyrimin | 1.2 | 2.4 | 42.4 | 57.9 | 11.5 | 12.3 | 5.8 | 6.4 | 5.0 | 5.0 |
| Flupyrimin | 2.0 | 4.0 | 43.3 | 58.1 | 11.8 | 12.7 | 5.8 | 6.5 | 5.0 | 5.0 |

TABLE 4
Efficacy of flupyrimin on Yield (Qt/ha) & Test Weight

| | Dose rates | | | |
|---|---|---|---|---|
| | Active rate | Form. rate | Test weight | |
| | (g Al/kg of | (ml/kg of | (1000 grain | Yield |
| Treatments | seed) | seed) | weight) | (Qt/ha) |
| Untreated | — | — | 53.4 | 35.1 |
| Flupyrimin | 1.2 | 2.4 | 55.3 | 37.4 |
| Flupyrimin | 2.0 | 4.0 | 56.5 | 37.8 |

It was observed that wheat grains/seeds treated with flupyrimin had substantially enhanced % germination rate, plant height, root length and plant vigor compared to untreated control. The efficacy of flupyrimin was also determined on yield (Qt/ha) and weight of grains which was found to be high.

### Example 4: Phytotonic Effect of Flupyrimin on Mustard

The present inventors have observed the phytotonic effect of flupyrimin in mustard seeds by determining the % germination, plant height, root length (cm) and plant vigor. The seeds were treated with 500 g/L flupyrimin flowable concentrate (FS) formulation. The observations were made at 30 DAS and 45 DAS (days after seeding).

TABLE 5
Efficacy of flupyrimin on plant height, root length
(cm) and plant vigor at 30 & 45 DAS in mustard

| | Dose rates | | | | | | Plant Vigor | |
|---|---|---|---|---|---|---|---|---|
| | Active | | Plant Height | | Root length | | (0-5 Index | |
| | rate | Form. rate | (cm) | | (cm) | | scale) | |
| | (g Al/kg | (ml/kg of | 30 | 45 | 30 | 45 | 30 | 45 |
| Treatments | of seed) | seed) | DAS | DAS | DAS | DAS | DAS | DAS |
| Untreated | — | — | 19.5 | 80.3 | 11.8 | 17.4 | 3.3 | 3.5 |
| Flupyrimin | 4 | 8 | 21.7 | 93.2 | 18.2 | 20.8 | 5.0 | 5.0 |
| Flupyrimin | 6 | 12 | 22.8 | 95.6 | 18.3 | 21.1 | 5.0 | 5.0 |

It was observed that mustard seeds treated with flupyrimin had substantially enhanced plant height, root length and plant vigor compared to untreated control.

We claim:

1. A method of regulating and improving plant growth, said method comprising applying flupyrimin to a locus of a plant, a plant part, a plant propagation material, or a part thereof.

2. The method as claimed in claim 1, wherein flupyrimin is applied as a formulation selected from the group comprising a suspension concentrate, a flow concentrate formulation, granular formulation, an emulsifiable concentrate formulation.

3. The method as claimed in claim 2, wherein flupyrimin is applied as a granular formulation.

4. The method as claimed in claim 3, wherein flupyrimin is in a concentration ranging from 1% to 10% w/w of the granular formulation.

5. The method as claimed in claim 2, wherein flupyrimin is applied as a flow concentrate formulation.

6. The method as claimed in claim 5, wherein flupyrimin is in a concentration ranging from 20% to 50% w/w of the flow concentrate formulation.

7. The method as claimed in claim 1, wherein flupyrimin is applied in an amount ranging from 50 g ai/ha to 500 g ai/ha.

8. The method as claimed in claim 1, wherein flupyrimin is applied in an amount ranging from 50 g ai/ha to 200 g ai/ha.

9. The method as claimed in claim 1, the plant propagation material is a seed.

10. The method as claimed in claim 9, wherein flupyrimin is applied at a rate ranging from 0.5 g ai/kg to 10 g ai/kg of seed.

11. The method as claimed in claim 9, wherein flupyrimin is applied at a rate ranging from 0.5 g ai/kg to 5 g ai/kg of seed.

12. The method as claimed in claim 1, wherein the plant is a cereal crop, oil seed crop or row crop.

13. The method as claimed in claim 12, wherein the cereal crop is selected from the group comprising wheat, rice, corn, rye, oats, barley, sorghum, and millets; wherein the row crop is selected from the group comprising sunflower, potato, canola, dry bean, field pea, flax, safflower, buckwheat, cotton, maize, soybeans, and sugar beets; wherein the oilseed crop is selected from the group comprising groundnut, rapeseed, mustard, soybean, sunflower, sesame, safflower and niger.

14. The method as claimed in claim 1, comprising applying flupyrimin and one or more insecticides selected from Acetylcholinesterase inhibitors, Ryanodine receptor modulators, GABA-gated chloride channel blockers, Sodium channel modulators, Nicotinic acetylcholine receptor competitive modulators, Glutamate-gated chloride channel allosteric modulators, Chordotonal organ TRPV channel modulators, Inhibitors of mitochondrial ATP synthase, Mite growth inhibitors affecting CHS1, moulting disruptors, Microbial disruptors of insect midgut membranes, Inhibitors of acetyl COA carboxylase, Mitochondrial complex electron transport inhibitors, Ecdysone receptor agonists, Inhibitors of chitin biosynthesis.

15. A method of regulating and improving plant growth comprising applying flupyrimin to a locus of a plant, a plant part, a plant propagation material, or a part thereof;
wherein flupyrimin is applied in an amount ranging from 50 g ai/ha to 500 g ai/ha to the locus of a plant, plant part, or a growing plant; and
wherein flupyrimin is applied in an amount ranging from 0.5 g ai/kg to 10 g ai/kg to a plant propagation material.
